(19) United States
(12) Patent Application Publication
(10) Pub. No.: US 2016/0189238 A1
(43) Pub. Date: Jun. 30, 2016

(54) SYSTEM AND METHOD FOR BUILDING A CAMPAIGN QUEUE WITH CONTEXTUALIZATION

(71) Applicant: Fanatical, Inc., Los Angeles, CA (US)

(72) Inventors: Garrett Law, Los Angeles, CA (US); Tyson Law, Los Angeles, CA (US); Josh McHugh, Los Angeles, CA (US)

(73) Assignee: Fanatical, Inc., Los Angeles, CA (US)

(21) Appl. No.: 14/586,455

(22) Filed: Dec. 30, 2014

(51) Int. Cl. G06Q 30/02; G06Q 50/00

(52) U.S. Cl. CPC G06Q 30/0269; G06Q 50/01

(57) ABSTRACT

A system for building a messaging campaign queue with contextualization includes a processor, an interactive display, and a memory module. The memory module includes stored computer-executable program code that, along with the memory module and the processor is configured to carry out a number of operations to create and customize a set of campaign interactions. One such operation involves creating a campaign queue based on a campaign type and a set of campaign parameters. The campaign queue includes a set of campaign interactions, each of which is associated with an intended recipient. Another such operation involves providing, via the interactive display, interaction context associated with the campaign interactions. An additional operation involves customizing the campaign interactions based on customization input received via the interactive display.

### TECHNICAL FIELD

The present disclosure relates generally to computing devices used for data tracking and analytics and to social media marketing platforms that use such devices, and more particularly to systems and methods for building a campaign queue with contextualization.

### BACKGROUND

Conventional computing solutions for social media marketing platforms generally enable only a broad and generic targeting of users that is not individualized, except for on a very small scale. For example, conventional solutions for brand marketing may allow for a broad engagement with a large audience, or for a targeted engagement with a small audience.

With the recent explosion in social media's popularity, however, has come the ability for individuals to interact with brands in a one-on-one fashion. This ability has introduced new problems for existing social media and online marketing solutions. To illustrate, one issue with conventional social media marketing platforms is that they do not enable individualized interactions with users on a larger scale. Responding to or engaging in thousands of individual interactions per week is not feasible using existing solutions, and particularly not if the interactions are to be personalized, systematic, and contextual. This is because, to individualize social media interactions on a large scale using existing platforms requires a brute-force approach that is time consuming and inaccurate (e.g., manually processing, managing, and tracking massive amounts of data). This brute-force approach not only fails to achieve an effective level of personalization, it also tends to result in duplicative efforts (leading to recipient annoyance). These failings cause problems because accuracy and personalization may be particularly important when engaging influential recipients and when doing so publicly.

Additional issues with existing solutions for online marketing, such as customer relationship management (CRM) tools and publishing and engagement tools, is that they are geared toward only responsive—not proactive—interactions with users (e.g., identifying/cataloging a discussion about a brand). Moreover, these existing solutions lack information and insight about relevant context and individual recipients' relationships with a brand or related brands (e.g., based on past interactions with/regarding the brand), do not allow for systematic messaging campaigns, are not well-suited to crafting personalized interactions, do not allow for tracking/analyzing results or performance of a marketing campaign, and are not customizable or amenable to scheduling (and particularly not on the fly) based on a particular goal for the marketing campaign. As such, these conventional solutions also require a brute-force approach that is not only clunky and slow, but is also prone to error and lacks the availability of information key to building compelling interactions with targeted recipients. To the extent such key information and individualized insight may be gleaned using conventional solutions, the process of doing so is manual—not automated—and requires mining information from disparate sources, and is thus overly time consuming.

Some conventional email marketing platforms are geared to more proactive campaigns and allow for some basic customization and personalization, but these platforms are effective only for either a small variety of messages sent in bulk (and typically all sent at once) or a smaller number of messages with a larger variety of content. As such, these platforms do not offer the ability or opportunity to personalize user/brand interactions on a large scale and with a level of customization that provides for effective marketing/interaction. In short, conventional solutions do not provide an effective platform for social media or online marketing, including building and engaging with audiences (e.g., on behalf of brands).

### BRIEF SUMMARY OF THE DISCLOSURE

In view of the above drawbacks with conventional solutions, there exists a long-felt need for computing solutions and devices for social media and online marketing platforms that enable and facilitate strategic, proactive, personalized, precise, systematic, organized, and contextualized interactions with individual recipients on a large and dynamic scale. Further, there is a need for such devices that track, process, and organize large amounts of data regarding such interactions, and that provide distilled, useful metrics based on that data. Additionally, there is a need for devices that use such metrics to synthesize actionable and relevant information about recipients' previous responses to marketing interactions, and that integrate that information into the process and strategy of building and deploying individualized interactions going forward.

Embodiments of the present disclosure provide systems, methods, and apparatus for building campaign queues with contextualization. The disclosed embodiments enable proactive, targeted, and systematic interaction with a large number of individual recipients—for example, through social media channels. Moreover, the present disclosure includes a platform that streamlines, tracks, and organizes large amounts of relevant data to provide important context for such interaction, and that facilitates the integration of this data and context into the process of building customized interactions (e.g., by way of campaign queues). Embodiments of the present disclosure also process contextual data to provide guidance regarding campaign queue strategies that are most likely to be effective.

According to one embodiment of the disclosure, an apparatus for creating and updating a campaign queue containing a set of campaign interactions includes a campaign selection module that selects a campaign type for the campaign queue. The apparatus also includes a campaign setup module that receives and processes a set of campaign setup parameters. Further, the apparatus includes a customization module that creates a set of campaign interactions based on the campaign type and the campaign setup parameters. Each of the campaign interactions is associated with an intended recipient, and the customization module also updates one or more of the campaign interactions based on a set of customization parameters.

The customization parameters may include content of the campaign interaction, timing associated with deployment of the campaign interaction, and a template for the campaign interaction. The customization module, in one instance, receives the set of customization parameters by way of a graphical user interface that presents a customization window for each of the campaign interactions. In one example implementation, based on a disposition input received via the customization window, the customization module approves the campaign interaction for deployment to the intended recipient, saves the campaign interaction, or removes the intended recipient from the campaign queue.

In one embodiment of the apparatus, each of the campaign interactions includes a campaign message, and apparatus also includes a messaging setup module that selects one or more templates for each of the campaign interactions. In a variation of this embodiment, for each of the campaign interactions, the messaging setup module suggests one of the templates based on the intended recipient associated with the campaign interaction. Existing templates may also be edited. Moreover, in another implementation, templates may be added and called up for later use. In another variation, the apparatus also includes an interaction deployment module that transmits the campaign interactions to the intended recipients. Before the interaction deployment module transmits the campaign interactions, the messaging setup module solicits user input and updates one or more of the campaign messages based on the user input.

Another aspect of the present disclosure involves a method for creating and updating campaign interactions. The method includes receiving and processing a set of campaign setup parameters. The method also includes creating a campaign interaction based on one or more of a campaign type, a campaign goal, a campaign strategy, and the set of campaign setup parameters. In one embodiment, the set of campaign setup parameters includes a target segment and a campaign size. In another embodiment, the set of campaign parameters includes campaign metadata. The campaign interaction corresponds to (e.g., is to be deployed to) one or more intended recipients. The campaign interaction may include a campaign message containing a text entry field and one or more tokens.

Furthermore, the method for creating and updating campaign interactions includes updating the campaign interaction based customization input specific to one or more of the intended recipients that correspond to the campaign interaction. In one example implementation, the campaign interaction includes a campaign message, and creating the campaign interaction includes selecting one of a set of campaign message templates. A variation of this implementation includes suggesting one or more of the campaign message templates based on interaction context associated with the one or more intended recipients. Templates may be used in a similar fashion for creating and updating campaign interactions other than campaign messages (e.g., wall-posts, comments, and so on, as described in detail below).

One embodiment of the method includes displaying the campaign interaction such that the campaign interaction may be updated and approved via a graphical user interface, and deploying the campaign interaction only after the campaign interaction is approved. Displaying the campaign interaction may entail displaying interaction context associated with the one or more intended recipients. The interaction context, in one instance, includes profile information, interaction history, and relationship analytics related to the intended recipient.

An additional aspect of the present disclosure includes a system for building a messaging campaign queue with contextualization. The system includes a processor, an interactive display, and a memory module. The memory module includes stored computer-executable program code. The memory module, the stored computer-executable program code, and the processor, are configured to create a campaign queue based on a campaign type and a set of campaign parameters. In one embodiment of the system, the set of campaign parameters includes a campaign goal and a campaign strategy, and the memory module, the stored computer-executable program code, and the processor are configured to provide a suggestion for one of the campaign goal and the campaign strategy based on the campaign type.

The campaign queue includes a set of campaign interactions, each of which is associated with an intended recipient. In an example implementation of the system, the memory module, the stored computer-executable program code, and the processor are configured to, for each of the one or more campaign interactions, receive an instruction via the interactive display. The instruction received may be to deploy the campaign interaction to the intended recipient, to save the campaign interaction, or to delete the campaign interaction from the campaign queue.

Moreover, the memory module, the stored computer-executable program code, and the processor, are configured to provide, via the interactive display, interaction context associated with one or more of the campaign interactions. The memory module, the stored computer-executable program code, and the processor, are further configured to customize one or more of the campaign interactions based on customization input received via the interactive display. In one embodiment, the customization input includes modifications to the campaign parameters, modifications to content of one or more of the campaign interactions, and modifications to deployment timing for one or more of the campaign interactions.

### BRIEF DESCRIPTION OF THE DRAWINGS

The present disclosure, in accordance with one or more various embodiments, is described in detail with reference to the following figures.

FIG. 1 illustrates an example system for creating and updating a campaign queue.

FIG. 2 illustrates an example apparatus for creating and updating a campaign queue.

FIG. 3 illustrates another example apparatus for creating and updating a campaign queue.

FIG. 4 is an operational flow diagram illustrating an example method for creating and updating campaign interactions.

FIG. 5 is an operational flow diagram illustrating another example method for creating and updating campaign interactions.

FIG. 6 illustrates an example computing module that may be used to implement various features of the disclosed systems, methods, and apparatus.

The figures are provided for purposes of illustration only and merely depict typical or example embodiments of the disclosure. The figures are described in greater detail in the description and examples below, and are not intended to be exhaustive or to limit the disclosure to the precise form disclosed. It should be understood that the disclosure may be practiced with modification or alteration, and that the disclosure may be limited only by the claims and the equivalents thereof.

### DETAILED DESCRIPTION

The present disclosure is directed to various embodiments of systems, methods, and apparatus for building campaign queues with contextualization. The details of some example embodiments of the systems, methods, and apparatus of the present disclosure are set forth in the description below. Other features, objects, and advantages of the disclosure will be apparent to one of skill in the art upon examination of the present description, figures, examples, and claims. It is intended that all such additional systems, methods, features, and advantages, etc., including modifications thereto, be included within this description, be within the scope of the present disclosure, and be protected by one or more of the accompanying claims.

Various embodiments of the disclosed systems, methods, and apparatus for building campaign queues with contextualization include, in various instances, creating and updating a campaign queue that includes a set of campaign interactions, creating and updating campaign interactions, and building a messaging campaign queue with contextualization. In various embodiments, the disclosed systems, methods, and apparatus are implemented in a computing environment using one or more computing devices. Such computing devices may be configured to be convenient for interactive interfacing applications, for example, to capture a user's input regarding campaign queues and interactions, and/or to display options or analysis regarding the same. Other applications of the disclosed embodiments and configurations thereof will be apparent to one of skill in the art upon examining the present disclosure.

Before going into a detailed description of the various embodiments of the systems, methods, and apparatus of the present disclosure, a high-level description of the process of building campaign queues with contextualization, including campaign queues made up of series of campaign interactions, will be provided. In light of the context provided by this high-level description, the details of the disclosed systems, methods, and apparatus, as well as variations thereon and modifications thereto (both of which are included within the scope of the present disclosure), will become more clear to one of skill in the art.

At a high level, building campaign queues with contextualization may involve creating and updating a campaign queue, which, in one example, includes a series of campaign interactions. Further, building campaign queues may entail four basic stages that a user/creator proceeds through, typically leading up to deploying campaign interactions to intended recipients. The user or creator, as referred to herein, may be a user of social media (e.g., an individual or a business entity/brand) or other online marketing mechanism (e.g., email, web pages, etc.), or may be an advertising agency acting on behalf of a brand. Generally, the user/creator of a campaign queue may be anyone with the desire to engage others through communications channels including email or the Internet, and/or through social media channels. The four stages may include the campaign selection stage, the campaign setup stage, the campaign interaction setup stage, and the customization stage.

For example, the campaign selection stage, which may be the first stage, may involve the user selecting a campaign type. The campaign type may, for instance, be a messaging campaign, an audience-building campaign, a brand-awareness campaign, and the like. For each campaign type, the user may customize or define the campaign in terms of a campaign goal and a campaign strategy. The campaign goal typically expresses the ultimate goal of the campaign, while the campaign strategy typically includes means or mechanism for achieving the campaign goal. The campaign type may depend on a particular social media platform the campaign is being designed for, though campaigns may be designed for implementation across multiple platforms. Embodiments of the present disclosure include various “pre-baked” options for campaign types, including goal-based, one-click, and custom campaigns, which are described in detail hereinbelow. Additional aspects of this stage will be further clarified and expounded upon in the description below.

Another high-level example stage for building campaign queues with contextualization is the campaign setup stage, which may be the second stage. This stage may involve, by way of illustration, one or more of selecting a group of intended recipients for the campaign, adding metadata to the campaign, specifying a campaign start and end date, specifying a social media account to associate with the campaign, specifying a size of the campaign (e.g., number of interactions to deploy/attempt), and specifying additional variables/constraints (e.g., time zone). In short, this stage may typically involve a number of front-end customization decisions and options used to build the campaign queue, though these decisions may be revisited and modified later on as well. Additional aspects of this stage will be further clarified and expounded upon in the description below.

A further illustrative stage, which may be the third stage in building campaign queues with contextualization, is the campaign interaction setup stage. In some example implementations, campaign interactions include an aspect of “conversation” or online communication with intended recipients, including (for example) publicly or privately writing or commenting on something intended recipients have done. The campaign interaction may entail, by way of example, initiating a message, wall post, tweet, email, chat, or the like. As such, setting up the campaign interaction may include using one or more templates (e.g., a message template) into which text and other content may be entered. The template may provide an initial starting point from the campaign interaction, which may be modified/customized later on. Additional aspects of this stage will be further clarified and expounded upon in the description below.

An additional example stage for building campaign queues with contextualization is customization stage, which may be the fourth stage. At this stage, the information received in the other three stages may be associated with each of the intended recipients to create a series of individualized campaign interactions. The series of campaign interactions may also be provided to the user in graphical format such that the user can process and/or revise/customize each campaign interaction in the campaign. Further, this stage may involve providing the user with relevant and multifaceted contextual data for each campaign interaction, such that the user may further customize, modify, and tailor each campaign interaction, as will be further described below.

After passing through these four stages, the user may approve the campaign queue or one or more campaign interactions for deployment (e.g., to the intended recipients), save campaign interactions for further review, or take other, informed actions, as the user deems necessary (e.g., remove intended recipients from campaign queues, etc.). Campaign interactions that are approved for deployment may then be processed and deployed to the intended recipients, and may be tracked and integrated back into the system models and analysis actionable to users in building future/ongoing campaigns.

Together, the above-described stages of building campaign queues with contextualization, including creating and updating a campaign queue that contains campaign interactions, allow for construction and execution of a “one-to-many” campaign, in which campaign interactions are individualized to recipients in a systematic way. The result is a campaign queue (e.g., including a scalable number of campaign interactions) with contextualization that integrates empirical intelligence—whether collected manually by an individual or automatically through computing means—and is more effective, streamlined, and conveniently managed, and that is deployable to a large number of recipients and across multiple platforms. In the context of the above-described stages, a detailed description of the various Figures of the present disclosure is provided, as follows.

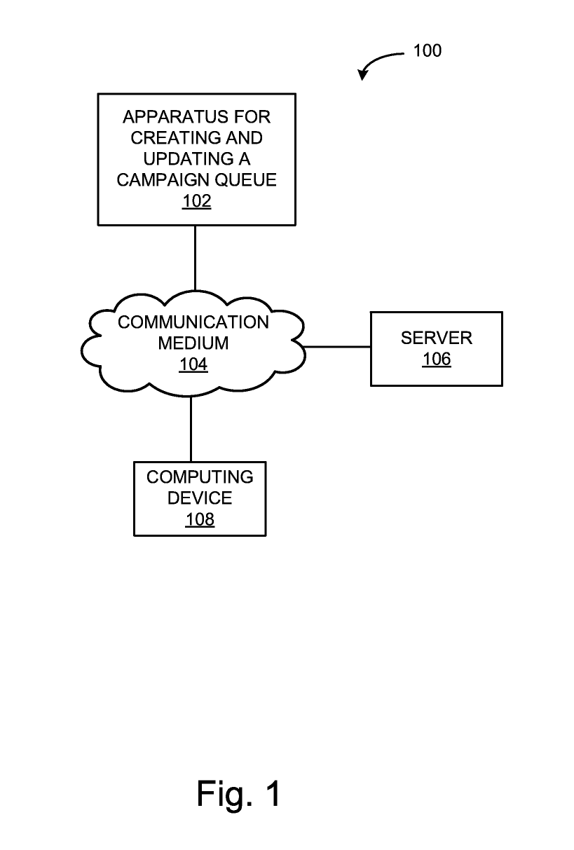

FIG. 1 is a schematic block diagram illustrating an example implementation of system 100 for creating a campaign queue that includes a set of campaign interactions. System 100 includes apparatus 102 for creating and updating a campaign queue, communication medium 104, server 106, and computing device 108. Embodiments of system 100 are capable of building campaign queues with contextualization, including, for example, enabling proactive, targeted, and systematic interaction with a large number of individuals, as well as convenient, organized tracking of the same. Moreover, embodiments of system 100 allow for creating and updating an individualized campaign queue by basing a set of campaign interactions on a set of customizable campaign setup parameters. Additionally, embodiments of system 100 update the campaign interactions based on a set of customization parameters. This updating feature allows system 100, in various embodiments, to build recipient-specific interactions tailored to intended recipients based on relevant contextualization information, including previous interaction content, timing, and/or structures, that have been determined to be effective.

An additional aspect of system 100 includes tailoring/updating the campaign interactions before deployment to the intended recipients. Being recipient-specific and easily/effectively customizable, the campaign queue and campaign interactions created and updated by system 100 may be targeted, so as to be more likely to get traction with or lead to conversion of intended recipients, while also being scalable to a large number of intended recipients, including across multiple marketing or other platforms (e.g., social media and Internet platforms) and channels. Such targeted, yet scalable campaign queues may be more effective in terms of driving a brand's traction and influence with recipients, for example, not only because the campaign interactions thereof are customized, but also because tracked and organized information regarding previous interactions with recipients may be conveniently incorporated into the campaign queues.

Referring again to FIG. 1, communication medium 104 may be used to connect or communicatively couple apparatus 102, server 106, and/or computing device 108 to one another or to a network, and communication medium 104 may be implemented in a variety of forms. For example, communication medium 104 may include an Internet connection, such as a local area network (“LAN”), a wide area network (“WAN”), a fiber optic network, Internet over power lines, a hard-wired connection (e.g., a bus), and the like, or any other kind of network connection. Communication medium 104 may be implemented using any combination of routers, cables, modems, switches, fiber optics, wires, radio (e.g., microwave/RF links), and the like. Communication medium 104 may be implemented using various wireless standards, such as Bluetooth®, Wi-Fi, 3GPP standards (e.g., 4G LTE), etc. Upon examining the present disclosure, one of skill in the art will recognize other ways to implement communication medium 104 for communications purposes.

Server 106 directs communications made over communication medium 104. Server 106 may include, for example, an Internet server, a router, a desktop or laptop computer, a smartphone, a tablet, a processor, a module, or the like, and may be implemented in various forms, include, for example, an integrated circuit, a printed circuit board, or in a discrete housing/package. In one embodiment, server 106 directs communications between communication medium 104 and computing device 108. For example, server 106 may update information stored on computing device 108, or server 106 may send/receive information to/from computing device 108 in real time.

Computing device 108 may take a variety of forms, such as a desktop or laptop computer, a smartphone, a tablet, a smartwatch or other wearable electronic device, a processor, a module, or the like. Computing device 108 may communicate with other devices over communication medium 104 with or without the use of server 106. In one embodiment, computing device 108 includes apparatus 102 for creating and updating a campaign queue. In various embodiments, apparatus 102 may be used to perform various processes described herein and/or may be used to execute various operations described herein with regard to one or more disclosed systems and methods. Upon studying the present disclosure, one of skill in the art will appreciate that system 100 may include multiple apparatus 102, communication media 104, servers 106, and/or computing devices 108, and that apparatus 102 may be embodied in or part of computing device 108.

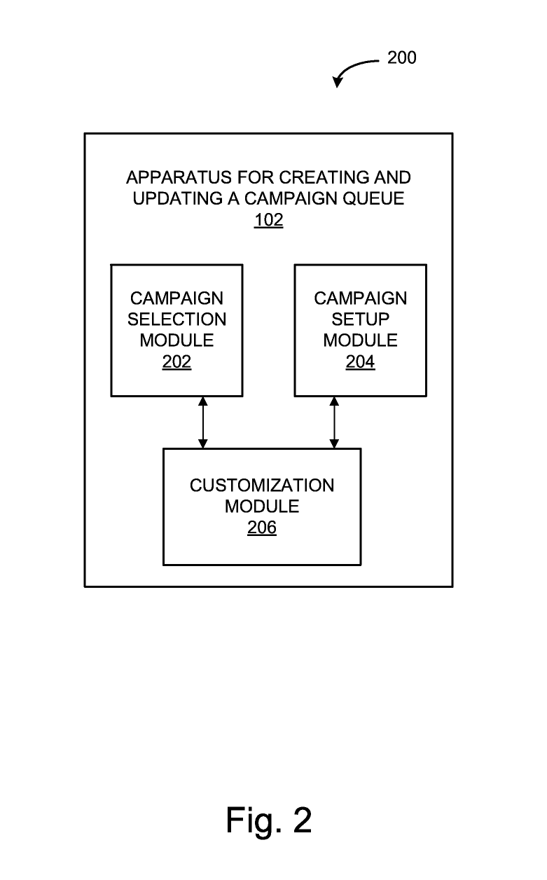

FIG. 2 is a schematic block diagram illustrating an embodiment of apparatus 200 for creating and updating a campaign queue. As illustrated, apparatus 200 includes apparatus 102, which, in turn, includes campaign selection module 202, campaign setup module 204, and customization module 206. In various implementations of the disclosure, apparatus 102 creates and updates a campaign queue that includes a set of campaign interactions, as follows: campaign selection module 202 selects a campaign type for the campaign queue; campaign setup module 204 receives and processes a set of campaign setup parameters; customization module 206 creates a set of campaign interactions (each of which is associated with an intended recipient) based on the campaign type and the campaign setup parameters; and customization module 206 updates one or more of the campaign interactions based on a set of customization parameters.

The customization parameters may be used to vary/update each campaign interaction (e.g., on an individual/recipient-specific basis). In one example implementation, the customization parameters include content delivered with/by the campaign interaction, timing associated with deployment of the campaign interaction, and a template for the campaign interaction. In one instance, the customization module receives the set of customization parameters by way of a graphical user interface (GUI) that presents a customization window for each of the campaign interactions. This allows for convenient access to each of the campaign interactions, whereby (for example) the campaign interactions may be modified/updated on an individual basis before being deployed. Based on a disposition received via the customization window, in one embodiment, customization module 206 approves the campaign interaction for deployment to the intended recipient, saves the campaign interaction, or removes the intended recipient from the campaign queue. In this manner, the customization module 206, in conjunction with the other, above-mentioned modules of apparatus 102, may create/update the campaign interactions to capture customization information targeted specifically to the intended recipient. Additional aspects and features of campaign selection module 202, campaign setup module 204, and customization module 206, are described below in further detail with regard to various processes, methods, and/or systems disclosed herein.

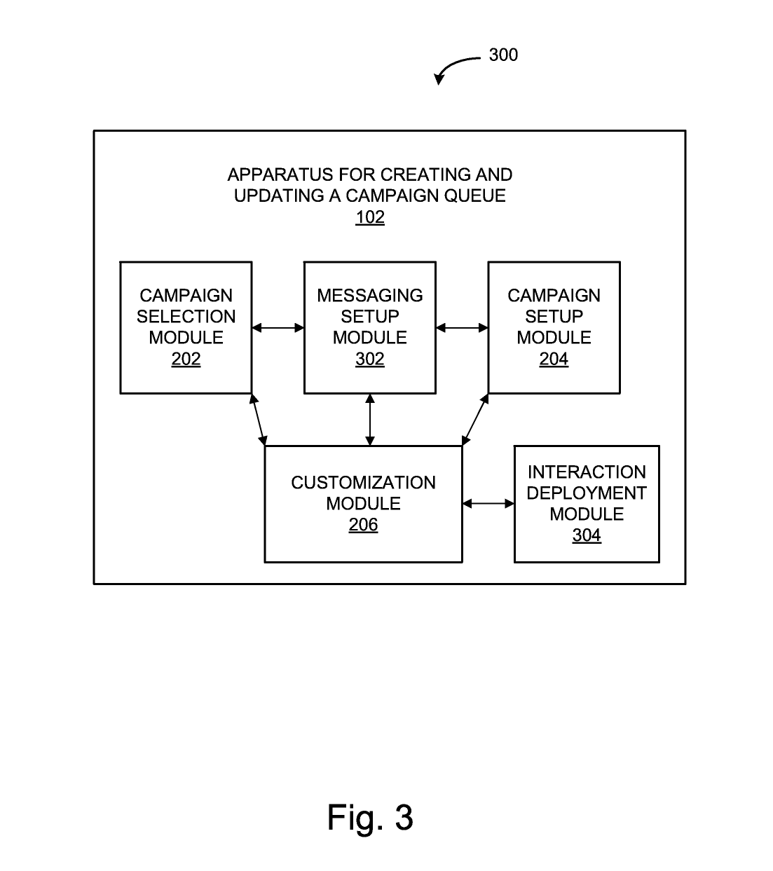

FIG. 3 is a schematic block diagram illustrating example embodiments of apparatus 300 for creating and updating a campaign queue. As shown in FIG. 3, apparatus 300 includes apparatus 102, which, in turn, includes campaign selection module 202, campaign setup module 204, and customization module 206. Apparatus 300 also includes messaging setup module 302 and interaction deployment module 304 in various embodiments. In one such embodiment, messaging setup module 302 selects one or more templates for campaign messages that are included in each of the campaign interactions. By providing multiple options for campaign messages, messaging setup module may facilitate the tailoring of campaign interactions to intended recipients. In an additional embodiment, messaging setup module 302 suggests one of the templates based on the intended recipient associated with the campaign interaction (e.g., based on contextual data or interaction context relevant to the intended recipient, as will be described further hereinbelow).

In one instance of the disclosure, interaction deployment module 304 transmits the campaign interactions to the intended recipients. Before interaction deployment module 304 does so, messaging setup module 302 solicits user input and updates one or more of the campaign interactions based on the user input. As such, interaction deployment module 304 may facilitate efficient review and/or customization of campaign interactions during/before deployment. Additional aspects and features of messaging setup module 302 and interaction deployment module 304 are described below in further detail with regard to various processes, methods, and/or systems disclosed herein.

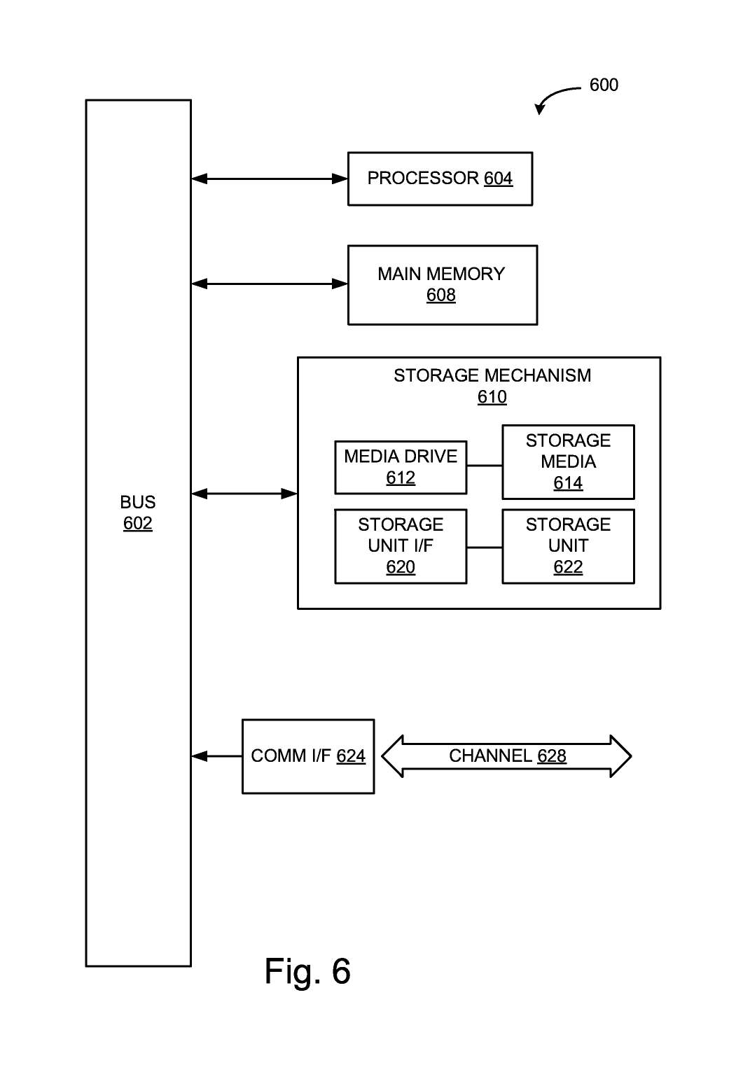

In various embodiments of the disclosure, one or more of campaign selection module 202, campaign setup module 204, customization module 206, messaging setup module 302, and interaction deployment module 304, is embodied in a computing device, such as, for example, computing device 108. Moreover, any of the modules described herein may be embodied in or distributed across one or more computing devices 108, or other hardware/devices (e.g., mobile devices), as will be appreciated by one of skill in the art after examining the present disclosure. Furthermore, any of the modules described herein may connect and/or communicatively couple to other modules described herein via communication medium 104. Example structures of these modules will be described in further detail hereinbelow with regard to FIG. 6.

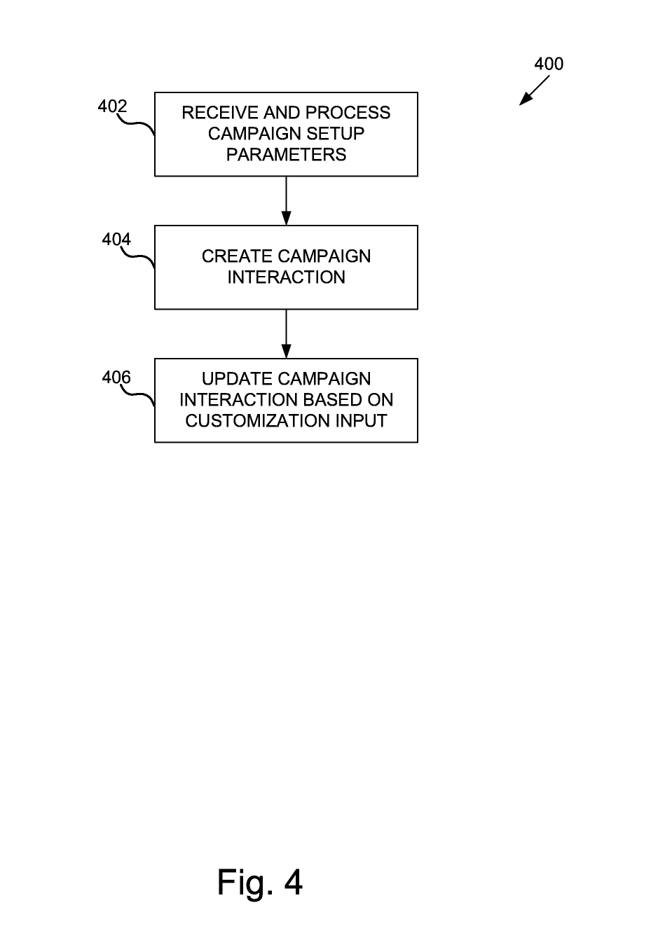

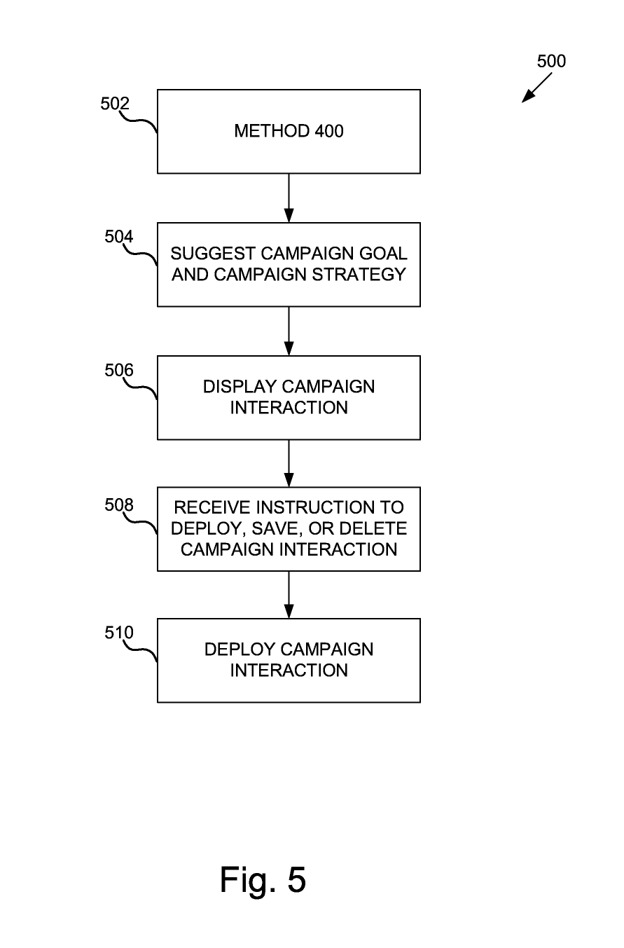

FIGS. 4 and 5 depict operational flow diagrams illustrating example embodiments of methods 400 and 500, respectively, for creating and updating campaign interactions, in accordance with the present disclosure. Through the operations of methods 400 and 500, a user/creator can build a targeted yet scalable campaign queue containing any number of campaign interactions to effectively and individually engage intended recipients.

FIG. 4 depicts an operational flow diagram illustrating example embodiments of method 400 for creating and updating campaign interactions, in accordance with the present disclosure. The operations of method 400 create and update campaign interactions based multiple inputs that allow for customization of the campaign interactions. For example, the inputs received by the operations of method 400 may include campaign type, campaign strategy, and campaign setup parameters. Further, method 400 includes customizing the campaign interactions to the respective intended recipients based on customization input. As such, method 400 provides the capability of building a series of campaign interactions that are tailored to the intended recipients' specific characteristics, and may further streamline the process of providing/customizing/tailoring such campaign interactions. In example implementations of method 400, apparatus 102 and/or one or more subcomponents/modules thereof perform various operations of method 400, which operations are described in further detail below.

As part of creating and updating campaign interactions, various embodiments of method 400 include (e.g., typically as part of initially setting up a campaign) receiving and processing one or more of a campaign type, a campaign goal, and a campaign strategy. These may be received/processed at any time, including, by way of example, concurrently with operation 402 (which is described below)—in some examples, however, these inputs are received initially, as part of the front-end of building out a campaign queue. There are a variety of different campaign types within the scope of this disclosure. Generally, the campaign type may be associated with an online marketing or promotion (including for social purposes) platform and may include a campaign and associated interactions executed via one or more social media platforms. For example, the campaign type may be a video campaign through YouTube®, may be a Twitter® campaign to increase friends/followers, may include promoting a YouTube® video through Facebook®, and so on.

In various examples, the campaign type may be broken down into and/or defined by a campaign goal and a campaign strategy. To illustrate, the campaign goal may be to promote content. Other examples of campaign goals include the following: to increase brand awareness, to promote/advertise an event or product, to increase a fan-base or number of followers, and so on. The campaign strategy may be thought of in terms of the means for achieving/executing the campaign goal. For example, if the campaign goal is to promote content (e.g., YouTube® video content), the campaign strategy may include getting wall-posts/shares of the video content, getting a certain number of views/“likes” of the video content, etc.

A user, in one example implementation, may customize all campaign-related options, including both the campaign goal and the campaign strategy. In another example, once the campaign goal is selected, method 400 may include suggesting the campaign strategy, or options for the campaign strategy, based on the selected campaign goal. To illustrate, the campaign goal may include growing the number of fans for a brand—as part of the campaign strategy, it may be suggested that the user post on a particular topic (e.g., a topic related to the brand or a topic of interest to the desired fan base). In other words, in this example of method 400, the campaign strategy includes one or more action items to be executed in furtherance of effectively achieving the selected campaign goal. One embodiment of method 400 includes a one-click campaign setup. This embodiment involves simply choosing a campaign type for which the campaign goal and the campaign strategy are already determined/optimized (e.g., based on an empirical analysis of most effective type/goal/strategy combinations in previous campaigns and/or based on normative data).

Referring again to FIG. 4, at operation 402, method 400 involves receiving and processing a set of campaign setup parameters that may be used to create/update one or more campaign interactions. Operation 402 may be performed as an initial matter (e.g., as part of the first high-level stage described above), for example, before any contextual/interaction information regarding target/intended recipients is gathered or tracked, and before any campaign interactions are created (e.g., according to operations described subsequently). The campaign setup parameters may include or define a target segment of intended recipients for one or more campaign interactions. The target segment may, by way of illustration, be a segment or group of “followers” (e.g., for Twitter®), a group of people who “like” a particular brand (e.g., for Facebook®), or may be defined based on geographical or other profile features, and the like. In some embodiments, the set of campaign setup parameters may be received and processed before the campaign strategy is suggested.

The campaign setup parameters may also include campaign metadata added to the campaign interactions that may aid for searching, tracking, sorting, and/or organizing campaign interactions. For example, such metadata may include a title for a set of campaign interactions, a description for a set of campaign interactions or a campaign, a creation date, the campaign type, the campaign goal, the campaign strategy, and so on. The campaign metadata may be added manually by the user, or may be added automatically (e.g., determined based on the campaign type, campaign strategy, campaign goal, or other of the campaign setup parameters).

Additionally, the campaign setup parameters may include a campaign size (e.g., total number of campaign interactions to create, or total campaign interactions to launch per time period), a campaign start and/or end date, a social media account to be associated with the campaign or from which to launch the campaign interactions, a time zone, and the like. Furthermore, the campaign setup parameters may be modified subsequent to the creation of campaign interactions, and the modifications thereto may be used to update the campaign interactions. Various embodiments of operation 402 may entail using campaign selection module 202 and/or campaign setup module 204.

At operation 404, method 400 involves creating a campaign interaction based on one or more of the campaign type, the campaign goal, the campaign strategy, and the set of campaign setup parameters. In various instances, one or more of the campaign type, the campaign goal, the campaign strategy, and the set of campaign setup parameters are received as input from a user. In other instances, one or more of these may be selected automatically and presented to the user as a suggested option for creating the campaign interaction (e.g., as described further below with regard to operation 504).

The campaign interaction created at operation 404 corresponds to one or more intended recipients—in other words, each campaign interaction is created to ultimately be deployed to at least one particular intended recipient. In various instances of the above-described campaign types, the associated campaign interactions typically include some form of “conversation”—e.g., online interaction involving communication with the intended recipient. In one embodiment of the disclosure, the campaign interaction includes a campaign message. Such a campaign message may be, for example, an email message or a message sent through a social media platform (e.g., a private message). In other embodiments, the campaign interaction includes a wall-post (e.g., to another social media account or web page), a chat interaction, a tweet, an article, other shared content (e.g., video, photo, hyperlinks, and the like), following a person, profile, page, or topic, “liking” a post or other object, or generally writing (e.g., publicly or privately) to an intended recipient or commenting on something the intended recipient has done. Various embodiments of operation 404 may entail using customization module 206.

Operation 406 of method 400 involves updating the campaign interaction based on customization input. The customization input is specific to one or more of the intended recipients. Receiving the customization input may entail varying the content of the campaign interaction itself. By way of illustration, when the campaign interaction includes a campaign message, the campaign message may include a text entry field and one or more tokens or placeholders, e.g., for the insertion of a name, greeting, URL, user handle, location, or other information useful to individualize the campaign message before the campaign message is deployed to the intended recipient(s). In such an example, customization input may be input directly into the campaign message.

In other examples, the customization input may involve varying the structure of the campaign interaction. For campaign messages, this may be done by selecting one of a set of campaign message templates presented to the user as options (e.g., by displaying the various message templates, by a drop-down, etc.). In this manner, different templates may be selected depending on the characteristics of the intended recipients. In one embodiment, message templates are, as an initial matter, randomly assigned to intended recipients. As information about the intended recipients is learned/tracked, however, messaging templates may be assigned to the intended recipients systematically (e.g., based on conversion rates, interaction context, etc.). The customization input, in other instances, alternatively or in addition to being associated with structure/content of a campaign interaction, may include modifications to one or more of the campaign parameters and/or modifications to the deployment timing for one or more of the campaign interactions.

One illustrative embodiment of method 400 includes suggesting one or more of the campaign message templates based on interaction context associated with the one or more intended recipients. For example, the interaction context may indicate that the intended recipient has previously responded positively to a particularly structured campaign message—e.g., a campaign message including a particular type of greeting, subject line, content, and so on. Based on this previous positive response, the same or a similar template may be suggested for the present campaign message being set up for the same intended recipient. In other examples, the campaign message template may be suggested based on interaction context with recipients who are not the intended recipient but have commonalities with the intended recipient.

FIG. 5 illustrates an operational flow diagram illustrating example operations that may be executed as part of method 500 for creating and updating campaign interactions. In addition to the operations of method 400, each of which is optionally contemplated in method 500 (e.g., at operation 502), the operations of method 500 provide for an interactive, convenient customization of campaign interactions that streamlines the customization process and integrates the same with deploying campaign interactions. This streamlining and integration enables the campaign interactions created by the operations of method 500 to be systematic, targeted, accurate, and customized according to the attributes and characteristics of the intended recipients, while at the same time being scalable according to campaign demands (e.g., to a large number of intended recipients). In example implementations of method 500, apparatus 102 and/or one or more subcomponents/modules thereof perform various operations of method 500, which operations are described in further detail below.

One particular operation of method 400 that may be included in method 500 is the operation of creating a campaign interaction based on a campaign type, a campaign goal, a campaign strategy, and a set of campaign setup parameters (operation 404). Referring again to FIG. 5, one embodiment of method 500 involves, at operation 504, suggesting (or providing a suggestion for) the campaign goal and the campaign strategy, based on the campaign type. For example, the campaign type may be indicated (e.g., at operation 404) to be a video campaign through YouTube®. In such an example, operation 504 may involve suggesting the campaign goal of achieving a maximum number of views, of getting as many “likes” or comments as possible, of getting certain types of comments, or of getting views/likes/comments from a certain group of intended recipients. By further way of example, the campaign strategy may include suggested means for achieving the associated/suggested campaign goal. To illustrate, the campaign strategy for achieving a maximum number of views of a video may be to include a provocative or mysterious caption to the video, to post the video to a varied number of high-traffic user pages, or to provide goal-based incentives for recipients who view the video.

Various embodiments of the disclosure may provide for varying levels of front-end customization in building a campaign queue. By way of example, and as mentioned above, the campaign selection stage may include three levels of front-end customization, as follows: custom campaign, in which the user may customize all available options (including, for example, campaign goal and campaign strategy); goal-based campaign, in which campaign strategy options are suggested based on a user-selected campaign goal; and one-click campaign, in which a plurality of suggestions for a combination of the campaign goal and the campaign strategy are pre-packaged according to campaign type and/or campaign goal.

Expounding on the one-click campaign option, it may be determined (e.g., by tracking campaign-related data), for example, that a particular campaign strategy is generally more effective for a given combination of campaign type and campaign goal. Such pre-packaged or pre-baked suggestions may enable the user to choose from a number of options that have been proven by experience in the marketplace. Although such options may not be per se customized for the user (e.g., compared to the custom campaign), they may be based on empirical data similar to that of the user, thus providing a trade-off between customization and convenience.

At operation 506, one example implementation of method 500 includes displaying the campaign interaction, which incorporates the campaign setup parameters, campaign type, and so on (according to, for example, operation 404), and that also may incorporate the campaign metadata, such that the campaign interaction may be updated and approved via a GUI and on a recipient-by-recipient basis. In this manner, the user may be provided with a convenient, heads-up display window for handling each of a series of campaign interactions.

One way of implementing operation 506 includes displaying a “preview” of the campaign interaction and modifying the preview as various templates are selected for the campaign interaction. Another example implementation includes displaying multiple previews simultaneously, such that different options for campaign interactions may be weighed against each other in parallel. By way of illustration, the GUI may display a first preview for a campaign interaction based on a first template while at the same time (e.g., side-by-side or stacked vertically) displaying a second preview for the campaign interaction based on a second template. Then, the preferred preview may be selected, further modified (optionally), and ultimately approved for deployment to the intended recipient (e.g., at operation 510, described below), saved for later, or deleted (e.g., in connection with operation 508).

In addition to being based on multiple templates, the various displayed previews may be based on additional variations in the customization input (e.g., as described above with regard to operation 406) or suggested customization input. An additional example of customization input includes interaction context. For instance, if the intended recipient has relevant previous interaction context, a particular blurb may be suggested based on that interaction context. This may entail reminding the intended recipient of the interaction context (e.g., noting that the intended recipient previously liked a page, commented on a post, etc.).

Referring again to GUI-based campaign interaction customization, the text or other content of the campaign interaction may be edited or replaced via the GUI. Moreover, the GUI may accept input regarding preferences for campaign interactions, such as overarching preferences regarding style/format, or specific preferences regarding particular campaign types, intended recipients, and so on. In any case, once the campaign interaction is updated, modified, and customized, it may be approved for deployment to the intended recipient, saved for later recall, or deleted.

In another example implementation, a series of previews, each corresponding to a different campaign interaction to be deployed to a different intended recipient, may be displayed via the GUI for updating/approval. This may entail the campaign interactions being aligned horizontally or vertically, such that they may be cycled through left to right or top to bottom (e.g., by swiping, clicking, or the like) and updated/approved in series. Alternatively, groups of campaign interactions may be displayed simultaneously for updating/approval, and upon approval (or other disposition), the next group of campaign interactions may be displayed. In such a group display scenario, each campaign interaction in the group may be customized as described above (e.g., based on a different template, with a different layout of tokens, and customized content based on the intended recipient). In one embodiment, regardless of the manner of displaying the campaign interactions for updating/approval, deploying the campaign interaction (e.g., at operation 510, described below) is done only after the campaign interaction is approved.

Further expounding upon the display and customization based on interaction context, in one example implementation of method 500, displaying the campaign interaction (e.g., at operation 506) includes displaying interaction context associated with the one or more intended recipients. To illustrate, the campaign interaction may correspond to a first intended recipient, and the GUI may provide the interaction context associated with the first intended recipient in the vicinity of the previewed campaign interaction for the first intended recipient. This may involve a listing of previous campaign interactions deployed to the first intended recipient and responses thereto (e.g., in sequential order), may involve segregating previous campaign interactions with the first intended recipient by outcome (e.g., to highlight successful versus unsuccessful interactions with the first intended recipient), may involve presenting statistics related to results of similar campaign interactions with recipients similar to the first intended recipient, and so on, including combinations of various types of interaction context. The interaction context may also be provided in graphical format, or as a combination of graphical and textual data. In one embodiment, the interaction context includes profile information (e.g., biographical information for the intended recipient and/or social media profile information for the intended recipient, including name, age, geographic location, etc.), interaction history, and relationship analytics.

Interaction history may include, for example, the history of interactions (e.g., recent conversations, messages, chats, or emails exchanged, subscription dates, etc.) between the social media account of the user/creator of the campaign queue or campaign interaction and the intended recipient, as well as history of interaction between the intended recipient and the user/creator's related social media account and other marketing channels of the user. By way of illustration, the interaction history for an intended recipient and a user/creator's Facebook® page may include all messages sent to and/or received from the intended recipient by that Facebook® page, as well as all interactions with the intended recipient by way of the user/creator's LinkedIn® page, email addresses, tweets, etc.

Relationship analytics may include a prediction of how likely the campaign interaction is to lead to a “conversion”—e.g., to result in action (e.g., a webpage or social media page/profile visit, share, comment, or another action, depending on the campaign type/goal) by the intended recipient. This prediction may be based on one or more of previous behavior by the intended recipient in similar circumstances, may be extrapolated from previous behavior by the intended recipient in different circumstances (in which case the extrapolation may be based on the difference in the circumstances), may be based on normative/statistical data of similar recipients in similar circumstances, etc. Likewise, the interaction context may include conversion counts and ratios related to the intended recipient (e.g., in previous campaign interactions), as well as other metrics.

The interaction context may also include a relationship indicator relating to the strength/quality/nature of the relationship between the user/creator and the intended recipient. The relationship indicator may also be extracted from the relationship between any combination of a similar user/creator (e.g., similar brand) or the user creator, and the intended recipient or a similar intended recipient (e.g., recipient with a similar profile). For example, the relationship indicator may be a number proportional to the influence that the user/creator has over the intended recipient, and may be based on the intended recipient's profile data, social activity/media data, and content specific engagement data (e.g., what type of content the intended recipient is most likely to engage with or be interested in). The relationship indicator may provide insight into how much effort should be expended in customizing the campaign interaction to the particular intended recipient. For example, where an intended recipient has a weaker relationship indicator, steps may be taken to compensate for that weakness, including providing more of an explanation of why a particular campaign interaction would be of interest to the intended recipient. Alternatively, where an intended recipient has a stronger relationship indicator, the campaign interaction may be modified to remind the intended recipient of this strength, thus increasing the likelihood of conversion/traction.

In sum, according to embodiments of the present disclosure, interaction context may be utilized to further enhance the effectiveness of campaign interactions of a campaign queue, particularly when the campaign interactions are specifically tailored to intended recipients based on the associated interaction context. In this vein, and as described above, the interaction context may also provide a basis for suggestions of how the campaign interactions may be specifically tailored to achieve traction/conversion with the intended recipients.

Whether or not the interaction context is incorporated into the campaign interaction, one embodiment of method 500 includes, at operation 508, receiving an instruction, via the GUI, to deploy the campaign interaction to the intended recipient, save the campaign interaction for later use, or delete the campaign interaction. In one example implementation of method 500, deploying the campaign interaction is done only after the campaign interaction is approved (e.g., via the GUI).

Deploying the campaign interaction may entail processing the campaign interaction with a series of campaign interactions into a queue such that the entire set of campaign interactions may be deployed nearly simultaneously. Alternatively, each campaign interaction may be deployed in real time upon approval, or may be deployed according to scheduling predetermined by the user (e.g., using the campaign setup parameters described above). In any case, the nature of deploying the campaign interaction may depend on the type of campaign interaction. For example, if the campaign interaction is a Facebook® wall post, deploying the campaign interaction may entail posting the wall post. Or, if the campaign interaction is a message (e.g., email, social media message, or the like), deploying may simply entail sending/transmitting the message to the intended recipient.

Once deployed, the campaign interactions may be tracked such that their reception by the intended recipients may inform future campaigns. For example, and as alluded to above, metrics that may be tracked include conversion (e.g., achievement of or progress toward the campaign goal) and other measurable occurrences. Such measurable occurrences may include whether the intended recipient clicked on a link included in the campaign interaction; whether the intended recipient subscribed to or unsubscribed from an account that received the campaign interaction; whether the intended recipient mentioned the user/brand or the campaign interaction (e.g., in a social media post); whether the intended recipient attended an event or made a purchase based on the campaign interaction, etc. The tracked results may also be organized and displayed to the user graphically.

Moreover, the tracked results may be presented to the user so as to provide, in addition to the results themselves, insight about the campaign interactions upon which the results are based. For example, the results may include an overall conversion rate for the campaign queue, total clicks generated (where applicable), total number of campaign interactions deployed, the status of the campaign (e.g., active, closed, etc.), a primary type of conversion (e.g., link click), target segments for the campaign and number of individuals in the target segments. The results may also include conversion rates based on the campaign setup parameters, campaign type, campaign goal, campaign strategy, and/or the customization input used for the campaign interactions. By way of illustration, the conversion rates may be provided on a template-by-template basis (e.g., for message templates). An additional aspect of displaying/organizing the results may include a tabular summary of each of the campaign interactions deployed and the results of the deployment. Organized and presented to the user in this manner, the results data may be used to create more effective campaigns going forward.

In one embodiment of the disclosure, the data collected through the above-described tracking of interactions can be stored and processed into a campaign prediction model. For example, the campaign prediction model may be able to use the collected empirical/results data to predict the likelihood that an individual campaign interaction and/or an entire campaign (e.g., one or more campaign queues) will be successful. This prediction for success may be based, by way of illustration, on the campaign goal, the campaign strategy, and/or on the campaign setup parameters. In this context, success may be measured in various ways, including whether a campaign goal is achieved, whether a campaign interaction leads to a conversion, whether a series of campaign interactions achieves a particular conversion rate, and so on.

The tracked data, in another embodiment, may be used to determine whether and the extent to which a campaign has reached a given population of group/segment of people (e.g., within the larger group of intended recipients to whom the campaign was deployed). This determination may be useful because the effect or ultimate return on investment of some campaigns may be based more on the “right” people/recipients (e.g., influential individuals)—rather than a total number of recipients—receiving and responding positively to the campaign. Determining the extent to which a campaign has penetrated a particular group may also be useful, for example, to ascertain a saturation level of the campaign. The saturation level may be thought of a point of diminishing return in terms of deploying interactions to a group of people, at which point deploying additional interactions is not likely to yield conversions/success. In this embodiment, the user may select or create a segment/group of interest (e.g., using the interactive display). Based on the tracked data, it may then be determined which intended recipients within that group responded to the campaign interaction deployed. The nature of the individual recipients' responses may also be determined based on the tracked data.

In one example implementation, an additional campaign may be created based on the determination of a previous campaign's penetration level with a group/segment. By way of illustration, it may be determined that a portion of a user-defined group (or segment) has not responded to a deployed campaign. That portion of the group may be analyzed, and a new campaign may be created to target that particular portion, and may be tailored to the individuals in that portion of the original intended recipient pool, including by incorporating their lack of response to the previous campaign. This recursive/adaptive approach to crafting/deploying campaigns not only avoids duplicate efforts to recipients who have responded already, but it also applies a strategic methodology to targeting those individuals that the campaign has not yet reached. In a variation on this implementation, the recursive approach may incorporate the nature of recipients' responses, and not just whether or not the recipients responded to the campaign.

FIG. 6 illustrates an example computing module that may be used to implement various features of a system for building a messaging campaign queue with contextualization, and that may be used to implement various features of additional systems, apparatus, and methods disclosed herein. One embodiment of the computing module includes a processor, an interactive display, and a memory module. The memory module includes stored computer-executable program code that, along with the processor and the memory module, may be configured to perform a number of operations—one embodiment is as follows. The memory module, the stored computer-executable program code, and the processor are configured to create a campaign queue based on a campaign type and a set of campaign parameters. The campaign queue includes a set of campaign interactions, each of which is associated with an intended recipient. The memory module, the stored computer-executable program code, and the processor are further configured to provide, via the interactive display, interaction context associated with one or more of the campaign interactions. Additionally, the memory module, the stored computer-executable program code, and the processor are further configured to customize one or more of the campaign interactions based on customization input received via the interactive display.

In one embodiment of the system for building a messaging campaign queue with contextualization, the customization input includes modifications to the campaign parameters, modifications to the content of one or more of the campaign interactions, and modifications to deployment timing for one or more of the campaign interactions. In an additional embodiment, the set of campaign parameters includes a campaign goal and a campaign strategy, and the memory module, the computer-executable program code, and the processor are configured to provide a suggestion for one of the campaign goal and the campaign strategy based on the campaign type. The system for building a messaging campaign queue, in one example implementation, involves the memory module, the computer-executable program code, and the processor being configured to receive an instruction via the interactive display. The instruction includes one of the following: to deploy the campaign interaction to the intended recipient, to save the campaign interaction, or to delete the campaign interaction from the campaign queue.

In some instances, features of the above-described embodiments of the system for building a messaging campaign queue may be substantially similar to those described above with reference to FIGS. 1 through 5 (and the accompanying systems, methods, and apparatus). In such instances, the memory module, the computer-executable program code, and the processor may be configured to execute those features. The example computing module may be implemented and may be used to implement the above-described various features in a variety of ways, as described above with reference to FIGS. 1 through 5, and as will be appreciated by one of ordinary skill in the art upon reading the present disclosure.

As used herein, the term module may describe a given unit of functionality that can be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 600 may also represent computing capabilities embedded within or otherwise available to a given device. For example, a computing module may be found in other electronic devices such as, for example, digital cameras, navigation systems, cellular telephones, portable computing devices, modems, routers, WAPs, terminals and other electronic devices that may include some form of processing capability.

Computing module 600 may include, for example, one or more processors, controllers, control modules, or other processing devices, such as a processor 604. Processor 604 may be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 may also include one or more memory modules, simply referred to herein as main memory 608. For example, preferably random access memory (RAM) or other dynamic memory, may be used for storing information and instructions to be executed by processor 604. Main memory 608 may also be used for storing temporary variables or other intermediate information during execution of instructions to be executed by processor 604. Computing module 600 may likewise include a read only memory (“ROM”) or other static storage device coupled to bus 602 for storing static information and instructions for processor 604.

The computing module 600 may also include one or more various forms of information storage mechanism 610, which may include, for example, a media drive 612 and a storage unit interface 620. The media drive 612 may include a drive or other mechanism to support fixed or removable storage media 614. For example, a hard disk drive, a solid state drive, a magnetic tape drive, an optical disk drive, a CD or DVD drive (R or RW), or other removable or fixed media drive may be provided. Accordingly, removable storage media 614 may include, for example, a hard disk, a solid state drive, magnetic tape, cartridge, optical disk, a CD or DVD, or other fixed or removable medium that is read by, written to or accessed by media drive 612. As these examples illustrate, removable storage media 614 can include a computer usable storage medium having stored therein computer software or data.

In alternative embodiments, information storage mechanism 610 may include other similar instrumentalities for allowing computer programs or other instructions or data to be loaded into computing module 600. Such instrumentalities may include, for example, a fixed or removable storage unit 622 and a storage unit interface 620. Examples of fixed/removable such removable storage units 622 and storage unit interfaces 620 can include a program cartridge and cartridge interface, a removable memory (for example, a flash memory or other removable memory module) and memory slot, a PCMCIA slot and card, and other fixed or removable storage units 622 and storage unit interfaces 620 that allow software and data to be transferred from removable storage unit 622 to computing module 600.

Computing module 600 may also include a communications interface 624. Communications interface 624 may be used to allow software and data to be transferred between computing module 600 and external devices. Examples of communications interface 624 may include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 may typically be carried on signals, which can be electronic, electromagnetic (which includes optical) or other signals capable of being exchanged by a given communications interface 624. These signals may be provided to communications interface 624 via a channel 628. This channel 628 may carry signals and may be implemented using a wired or wireless communication medium. Some examples of a channel may include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 608, storage unit interface 620, removable storage unit 622, removable storage media 614, and channel 628. These and other various forms of computer program media or computer usable media may be involved in carrying one or more sequences of one or more instructions to a processing device for execution. Such instructions embodied on the medium are generally referred to as “computer program code,” “computer-executable program code,” or a “computer program product” (which may be grouped in the form of computer programs or other groupings). When executed, such instructions may enable the computing module 600 to perform features or functions of the present application as discussed herein.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described example embodiments.

What is claimed is:

1. An apparatus for creating and updating a campaign queue comprising a set of campaign interactions, the apparatus comprising:
a campaign selection module that selects a campaign type for the campaign queue;
a campaign setup module that receives and processes a set of campaign setup parameters; and
a customization module that creates a set of campaign interactions based on the campaign type and the campaign setup parameters, wherein the set of campaign parameters comprises campaign metadata that facilitates searching, tracking, sorting, and organizing campaign interactions, wherein each of the campaign interactions is associated with an intended recipient, and wherein the customization module updates one or more of the campaign interactions based on a set of customization parameters.

2. The apparatus of claim 1, wherein each of the campaign interactions comprises a campaign message; and wherein the apparatus further comprises a messaging setup module that selects, on an intended-recipient basis, one or more templates for each of the campaign interactions.

3. The apparatus of claim 2, further comprising an interaction deployment module that transmits the campaign interactions to the intended recipients; wherein, before the interaction deployment module transmits the campaign interactions, the messaging setup module solicits user input and updates one or more of the campaign messages based on the user input.

4. The apparatus of claim 2, wherein, for each of the campaign interactions, the messaging setup module suggests one of the templates based on the intended recipient associated with the campaign interaction.

5. The apparatus of claim 1, wherein the customization parameters comprise content of the campaign interaction, timing associated with deployment of the campaign interaction, and a template for the campaign interaction.

6. The apparatus of claim 1, wherein the customization module receives the set of customization parameters by way of a graphical user interface that presents a customization window for each of the campaign interactions.

7. The apparatus of claim 6, wherein, based on a disposition input received via the customization window, the customization module approves the campaign interaction for deployment to the intended recipient, saves the campaign interaction, or removes the intended recipient from the campaign queue.

8. A method for creating and updating campaign interactions, the method comprising:
receiving and processing a set of campaign setup parameters;
creating a campaign interaction based on one or more of a campaign type, a campaign goal, a campaign strategy, and the set of campaign setup parameters, wherein the campaign interaction corresponds to one or more intended recipients;
displaying the campaign interaction and interaction context associated with the one or more intended recipients; and
updating the campaign interaction based on customization input specific to one or more of the intended recipients that correspond to the campaign interaction.

9. The method of claim 8, wherein the set of campaign setup parameters comprises a target segment, a campaign size, and campaign metadata.

10. The method of claim 8, further comprising estimating the likelihood that the campaign interaction will be successful.

11. The method of claim 8, wherein the campaign interaction comprises a campaign message comprising a text entry field and one or more tokens.

12. The method of claim 8, wherein the campaign interaction comprises a campaign message; wherein creating the campaign interaction comprises selecting one of a set of campaign message templates; and wherein the campaign message template is selected based on the intended recipient.

13. The method of claim 12, further comprising suggesting one or more of the campaign message templates based on interaction context associated with the one or more intended recipients.

14. The method of claim 8, wherein updating the campaign interaction is done via a graphical user interface; and further comprising deploying the campaign interaction only after the campaign interaction is approved.

15. The method of claim 14, further comprising:
tracking the deployed campaign interaction;
evaluating the intended recipient's reception of the campaign interaction; and
using the evaluated reception to inform a subsequent campaign interaction.

16. The method of claim 8, wherein the interaction context comprises profile information, interaction history, and relationship analytics.

17. A system for building a messaging campaign queue with contextualization, the system comprising:
a processor;
an interactive display; and
a memory module comprising stored computer-executable program code, wherein the memory module, the stored computer-executable program code, and the processor are configured to:
create a campaign queue based on a campaign type and a set of campaign parameters, the campaign queue comprising a set of campaign interactions, each of the campaign interactions associated with an intended recipient, each campaign parameter of the set of campaign parameters comprising a campaign goal and a campaign strategy;
provide, via the interactive display, interaction context associated with one or more of the campaign interactions; and
customize one or more of the campaign interactions based on customization input received via the interactive display.

18. The system of claim 17, wherein the memory module, the stored computer-executable program code, and the processor are further configured to provide a suggestion for one of the campaign goal and the campaign strategy based on the campaign type.

19. The system of claim 17, wherein the customization input comprises a modification to the campaign parameters, a modification to content of one or more of the campaign interactions, and a modification to deployment timing for one or more of the campaign interactions.

20. The system of claim 17, wherein the memory module, the stored computer-executable program code, and the processor are further configured to, for each of the one or more campaign interactions, receive an instruction to:
deploy the campaign interaction to the intended recipient;
save the campaign interaction; or
delete the campaign interaction from the campaign queue;
wherein the instruction is received via the interactive display.
